(19) United States
(12) Patent Application Publication
(10) Pub. No.: US 2010/0083773 A1
(43) Pub. Date: Apr. 8, 2010

(54) SAMPLE CARRIER

(75) Inventor: Dieter Schmiedl, Schmolln (DE)

Correspondence Address: KNOBBE MARTENS OLSON & BEAR LLP, 2040 MAIN STREET, FOURTEENTH FLOOR, IRVINE, CA, 92614, US

(73) Assignee: EPPENDORF AG, Hamburg (DE)

(21) Appl. No.: 12/572,954

(22) Filed: Oct. 2, 2009

(30) Foreign Application Priority Data
Oct. 4, 2008 (DE) 20 2008 013 218.5

(51) Int. Cl. B01L 3/02

(52) U.S. Cl. 73/864.01

(57) ABSTRACT

Sample carrier in form of a microliter pipette tip for securing microbiological, virological, genetic, medical, veterinary medical, forensic, criminalistic and technical samples, having technical means for being attachable to a tip holder, a conventional microliter pipette or a medical syringe and having an opposite pointed outlet with an opening, characterized in that a sample collector is attached in such a way directly in the region of said opening, that wetting of the sample collection is feasible from the inside of the microliter pipette tip through said opening.

### CROSS-REFERENCE TO RELATED PATENT APPLICATIONS

This application claims priority to and the benefit of German Utility Model Application No. DE 20 2008 013 218.5, filed Oct. 4, 2008, the disclosure of which is incorporated herein by reference in its entirety.

### BACKGROUND

1. Field

The invention relates to a sample carrier based on a microliter pipette tip. Said sample carrier is provided for securing evidence in microbiological, virological, genetical, medical, veterinary medical, forensic, criminalistic and technical fields and is designed as a component of an apparatus systick for sampling, identifying, storing and further processing, and providing of samples to be used as evidence, respectively.

2. Discussion of the Related Technology

In scientific, clinical, veterinary, technical or other research, development or routine laboratories so called microliter pipette tips of different style and size have been used for many years. Their construction normally depends on the fix volume, range of volume or specific application.

All pipettes have in common that they can be tipped/equipped with one or more exchangeable tips depending on the application purpose. In practice microliter pipette tips merely serve as pipetting aids. They are in most cases provided for single use and are discharged after use. Depending on the media to be pipetted and the required accuracy pipettes and their respective tips are harmonized.

Collecting systicks with cotton wool swabs are prevailing as actual sample carriers in forensics and criminalistics. These swabs mostly consist of a shaft/stick made of wood, metal or plastics to which a piece of cotton wool is provided on one or both ends. A sample can be taken from a substrate by rubbing off or wiping. The sample may then be further processed.

The predominant number of dry or dried samples can or should be rubbed off with slightly wetted cotton wool carriers only. The swab must hence be wetted manually from outside using a sterile water bottle carried along. The much approved smear test swabs for medical or microbiological purposes only conform to the specific requirements of DNA analysis when said test swabs are immediately dried after use.

The reason for it being that DNA is a sensible analytic material, which degrades quickly under moist storage conditions. Drying of the drawn samples is complicated, since contaminations by foreign DNA or a mixing up of samples must be avoided unconditionally. If the cotton wool carrier is not allowed to dry immediately after sample collection the original samples will be spoiled after only a short time. Most of the swabs/cotton wool swabs having a long shaft are normally disposed of in closable sample glasses or cardboard boxes and then sealed. The required space is disproportionally high when considering that only the small amount of cotton actually functions as sample carrier. Some users therefore break off the front end of the swabs used. The thus required predetermined breaking point in the swab shaft, however, makes the whole swab mechanically instable.

A further fundamental drawback of conventional sample carriers in form of swabs is that they cannot be directly inscribed and cannot be provided with a barcode, respectively. It is rather accepted to store swabs in labelled test tubes or boxes until further processing. The risk of mixing up samples is very high after removal of the swab from its temporary storage.

German utility model DE 20 2007 001 898 for example describes a container and medical swab for biological materials.

EP 1 234 165 presents a sample container for conservation and dry storage of DNA/RNA containing material.

It would be desirable to provide a sample collecting system having an appropriate sample carrier which will not exhibit the identified problems of wetting and drying as well as safe storage and labelling of the samples.

### SUMMARY

The present invention is generally related to a sample carrier in form of a microliter pipette tip for securing microbiological, virological, genetic, medical, veterinary medical, forensic, criminalistic and technical samples, having technical means for being attachable to a tip holder, a conventional microliter pipette or a medical syringe and having an opposite pointed outlet with an opening, characterized in that a sample collector is attached in such a way directly in the region of said opening, that wetting of the sample collection is feasible from the inside of the microliter pipette tip through said opening. In one embodiment, the sample carrier may be characterized in that said sample collector is formed as swab tip, as brush tip or as a roll. In another embodiment, the sample carrier may be characterized in that said roll is a cylindrically formed pipette shoulder covered with tissue, blotting paper or a special carrier. In still another embodiment, the sample carrier may be characterized in that said sample collector is a combination of swab tip, brush tip and roll, respectively. In still another embodiment, the sample carrier may be characterized in that a barcode, a transponder or the like is attached to said microliter pipette tip.

### BRIEF DESCRIPTION OF THE DRAWINGS

FIG. 1 shows sample collectors that are formed as swab tips and in FIG. 4 these tips are presented with applied barcode.

FIG. 2 shows sample collectors that are formed as brush tips and in FIG. 5 these tips are presented with applied barcode.

FIG. 3 shows sample collectors that are formed as roller tips and in FIG. 6 these tips are presented with applied barcode.

### DETAILED DESCRIPTION OF EMBODIMENTS

The problem to be solved therefore is to be seen in the development of a sample carrier, particularly for forensic and criminalistic purposes.

The problem has been solved by the present invention which provides a sample carrier in form of a microliter pipette tip for securing microbiological, virological, genetic, medical, veterinary medical, forensic, criminalistic and technical samples, which microliter pipette tip has technical means for being attachable to a tip holder, a conventional microliter pipette or a medical syringe and has an opposite pointed outlet with an opening, characterized in that a sample collector is attached in such a way directly in the region of said opening, so that wetting of the sample collection is feasible from inside the microliter pipette tip through said opening.

In another embodiment of the invention the sample collector is formed as swab tip, as brush tip or as roll.

In still another embodiment of the invention the roll is a cylindrically formed pipette shoulder covered with tissue, blotting paper or a special carrier.

In another embodiment of the invention the sample collector is a combination of a swab-tip, brush tip and roll, respectively.

In still another embodiment of the invention a barcode, a transponder or the like is attached to the microliter pipette tip.

According to the invention it is proposed to redesign microliter pipette tips known per se so that they can be applied as sample carrier for the indicated application.

The actual sample collector is therefore directly attached to the opening of the outlet of the microliter pipette tip. The sample collector is formed as swab tip, as brush tip for turning up hair, textile fibers, feathers, fuzzes or the like (brush tip) or as a turnable cylindrically formed pipette shoulder being covered with tissue, blotting paper or a special carrier and serves for collecting samples by rolling (roller tip).

Combinations of two or all mentioned embodiments are also feasible. The sample collector can be wetted through said opening from the outside and the inside.

According to the invention the sample carriers formed as microliter pipette tips can be clipped on simple tip holders, conventional microliter pipettes or medical tips. They can also be preserved in properly dimensioned dry tubes if required.

It is also possible to attach a barcode, a transponder or the like to the outer surface of the sample carrier.

Such further developed microliter pipette tips can be applied advantageously for taking forensic or microbiological samples. Additionally, they are suitable for transport and preserving for long time periods.

It is proposed to use constructively adapted pipettes for sample collection and sample drawing for an optimal handling of the sample carriers. When being analyzed in the lab the sample carriers can be further processed with the microliter pipettes present in the laboratory without any problem.

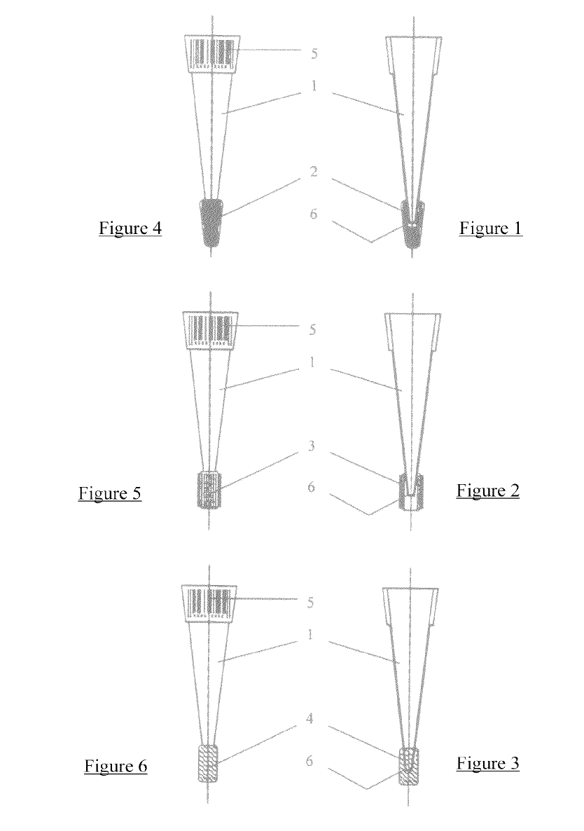

The following embodiments of the invention relate to sample carriers according to the invention, in which the sample collectors are formed as swab tips (FIG. 1), brush tips (FIG. 2), or roller tips (FIG. 3). In FIG. 4, FIG. 5 and FIG. 6 these tips are each presented with applied barcode. Alternatively, also a transponder or another advantageous labelling can be used.

The reference signs used in the drawings have the following meaning:
1 microliter pipette tip
2 cotton wool wad (swab tip)
3 micro brush (brush tip)
4 roll (roller tip)
5 barcode, transponder
6 opening.

As can be seen in all the figures shown a microliter pipette tip 1 of conventional style having technical means for being attached to a tip holder is a conventional microliter pipette or a medical formed tip and having an opening 6 on the pointed opposite outlet.

Alternatively, a swab tip 2, a brush tip 3, and a roll 4 covered a with tissue, a blotting—or special paper, respectively, is appropriately disposed, but always disposed in such a way in the region of said opening 6 that said mentioned technical means can be wetted from the inside through said opening 6.

Combinations of swab tip 2, brush tip 3, and roll 4 are possible and in certain cases reasonable.

The microliter pipette tip 1 can be provided with a bar code 5, transponder 5 or the like in any embodiment, namely as swab tip, brush tip and roller tip. Sample carriers formed as swab tips, i.e. microliter pipette tip 1 with applied swab tip 2, are full-fledged smear swabs and suited at best for tasks in microbiology, genetics or forensics.

Said sterile swab tip 2 consists normally of cotton, viscose, alginate, vinyl alcohol or any other material suitable for the operation purpose. Said swab serves for collecting all kinds of samples, for example germs, saliva, sweat, smallest blood amounts, semen, secretions or cosmetics.

Wetting of said cotton wool is always necessary when DNA samples are rubbed off from dry or absorptive substrates.

Said swab tips can be wetted conservatively by means of a dropping bottle analogously to the known cotton-shaft swabs. When inserting correspondingly constructed collecting pipettes (forensipettes/forensic pipettes) they can be wetted conveniently from the inside, such that further wetting is possible without any problem even during rubbing off a sample. Depending on the desired use swab tips are recommended in different sizes and, as already common in the lab, in clearly distinguishable colour design, for example white, yellow or blue, having swab tips 2 with varying collecting capacity. Thin swab tips can, for example, be applied for collecting dirt samples from finger nails.

The brush tip 3 is designed for collecting hair, textile fibers, feathers or fuzzes by rotational movements. Wetting takes place in a conservative way, preferably by means of a forensipette.

The roll 4 is a cylindrically formed pipette shoulder which is covered with tissue, blotting paper or a special carrier, for example FTA-paper from the company Whatman Inc., and is intended to be used in collecting samples by rolling. Wetting takes place as described above.

The barcodes 5 or transponders 5 are advantageously mounted from outside on the upper part of the microliter pipette tip 1 and thus do not contact the sample. The samples can therefore be clearly assigned.

In their function as sample carriers said swab tips, brush tips or roller tips can be stored contact-free in dry tubes or other suitable containers. Adhering samples can thus be preserved for a long time period or are available for microbiological purposes when stored in a culture medium. Even demanding microbiological germs can be safely transported if introduced into respective transport media. The sample carriers according to the invention are suitable either for dry as well as wet microbiological smears. Within the technical area of securing DNA-samples said sample carriers can be excellently applied for forensic smears of the oral mucosa for relationship and paternity studies.

By said already mentioned storage of used sample carriers in tightly sealing containers having drying agents biological samples, for example DNA samples, can be preserved even without previous analysis directly over long time periods in the line with DNA-banking and can be extracted for examination at a future date. Extraction of the sample carriers should advantageously be done contamination-free by means of conventional laboratory pipettes.

Said attached barcode 5 or transponder 5 provides a high level of security from mixing up samples. Also other advantageous labellings can be applied.

What is claimed is:

1. A sample carrier in a form of a microliter pipette tip for securing microbiological, virological, genetic, medical, veterinary medical, forensic, criminalistic and technical samples, said carrier comprising
an attachment opening that is attachable to a tip holder of a microliter pipette or a medical syringe;
a pointed outlet with an opening, said pointed outlet being located opposite said attachment opening; and
a sample collector attached in such a way directly in a region of said opening of said pointed outlet, that wetting of the sample collector is feasible from the inside of the microliter pipette tip through said opening.

2. The sample carrier according to claim 1, wherein said sample collector is formed as swab tip, as a brush tip or as a roll.

3. The sample carrier according to claim 2, wherein said sample collector is formed of a roll that is a cylindrically formed pipette shoulder covered with tissue, blotting paper or a special carrier.

4. The sample carrier according to claim 1, wherein said sample collector comprises a combination of two or more of a swab tip, a brush tip and a roll.

5. The sample carrier according to claim 1, wherein a barcode, a transponder or other identifying indicium is attached to said microliter pipette tip.

6. A method of securing a microbiological, virological, genetic, medical, veterinary medical, forensic, criminalistic or technical sample, comprising
providing a sample carrier according to claim 1; and
collecting said sample onto said sample collector.
